(19) United States
(12) Patent Application Publication
(10) Pub. No.: US 2013/0269862 A1
(43) Pub. Date: Oct. 17, 2013

(54) METHOD OF FABRICATING IN-MOLD RELEASE FILM

(71) Applicants: Chun-Tang Hsu, New Taipei City (TW); Sih-Ren Fu, Taipei City (TW); Kun-Huang Hsu, New Taipei City (TW)

(72) Inventors: Chun-Tang Hsu, New Taipei City (TW); Sih-Ren Fu, Taipei City (TW); Kun-Huang Hsu, New Taipei City (TW)

(21) Appl. No.: 13/607,813

(22) Filed: Sep. 10, 2012

(30) Foreign Application Priority Data
Apr. 12, 2012 (TW) 101112967

(51) Int. Cl. B32B 38/06

(52) U.S. Cl. 156/219

(57) ABSTRACT

A method of fabricating an in-mold release (IMR) film is disclosed. A carrier film including a substrate and a resin layer having thereon an embossed pattern, such as wood vein pattern, on a side of the substrate is provided. A composite film is then laminated and pressed onto the carrier film to thereby transferring the embossed pattern to the composite film.

### BACKGROUND OF THE DISCLOSURE

1. Technical Field

The present disclosure relates to in-mold release (IMR) techniques. More particularly, the present disclosure relates to a method of fabricating an in-mold release (IMR) film and a method for forming a plastic object with concave and convex textures or patterns on its surface by using the IMR film.

2. Description of the Prior Art

Plastic members or parts are widely used in electronic products as mechanical objects such as casing or housing of computers or cell phones, keyboard, etc. The advantages of plastic components are low cost, light weight and well plasticity for being easily completed with advancing technologies nowadays. However, the drawback is lacking textures on the appearance.

In the past, to provide the appearance with concave and convex textures or patterns on the surface of the plastic members, mold has to be etched or treated by electrical discharge machining and processing in advance. However, one single mold can only show a single texture pattern. To present the appearance of another texture pattern, a second set of molds are required, so the cost is very high and the production efficiency is low.

Therefore, improving the production methods and technologies with concave and convex textures or patterns is capable of avoiding the above prior art shortcomings in the plastic members or parts to reduce the cost or increase the production efficiency.

### SUMMARY

It is one object to provide an improved IMR film in order to solve the above-mentioned prior art problems and shortcomings.

According to one aspect of this disclosure, a method of fabricating an in-mold release (IMR) film is disclosed. A carrier film includes a substrate and a resin layer having thereon an embossed pattern, such as veined pattern, on a side of the substrate is provided. A composite film is then laminated and pressed onto the carrier film to thereby transferring the embossed pattern to the composite film

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the embodiments, and are incorporated in and constitute a part of this specification. The drawings illustrate some of the embodiments and, together with the description, serve to explain their principles. In the drawings:

FIG. 1 to FIG. 5 are schematic, cross-sectional diagrams showing a method of fabricating an IMR film in accordance with one embodiment; and

FIG. 6 and FIG. 7 illustrate an exemplary method of forming a plastic member or appearance object with texture of concave and convex veins or patterns by using the IMR film 1 in combination with the in-mold pattern transfer technique according to this disclosure.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following detailed description, reference is made to the accompanying drawings, which form a part hereof, and in which is shown by way of illustration specific examples in which the embodiments may be practiced. These embodiments are described in sufficient detail to enable those skilled in the art to practice them, and it is to be understood that other embodiments may be utilized and that structural, logical and electrical changes may be made without departing from the described embodiments. The following detailed description is, therefore, not to be taken in a limiting sense, and the included embodiments are defined by the appended claims.

The present disclosure pertains to a method of making an in-mold release (IMR) film and a method of forming plastic members or appearance objects with veinedconcave and convex textures or patterns via the IMR film combining the in-mold pattern transfer technology with it. The in-mold pattern transfer technology, which has been widely used in the fields such as automotive, appliance, computer, game consoles and other consumer electronic products, often use molding machines to transfer ink pattern printed on the thin-film in the mold cavity during injection molding process, thereby decorating the surface of the injection molded plastic member or object. Since the finished product is surface decorated directly in the mold cavity, the high production efficiency can be increased.

In the past, in-mold pattern transfer technology could only improve the visual performance of the product color, text, pattern mold, but was never used in the improvement of the appearance of the touch. Thus, the present disclosure provides a method of making the IMR film and take advantages of high production efficiency of the in-mold pattern transfer technology, to form plastic members or objects (such as chassis or keyboard keycap) with concave and convex textures at lower cost. This way, by changing the IMR film to meet different needs of the appearance of textures or patterns in the same mold, diversification can be achieved and the cost of new molds can be spared.

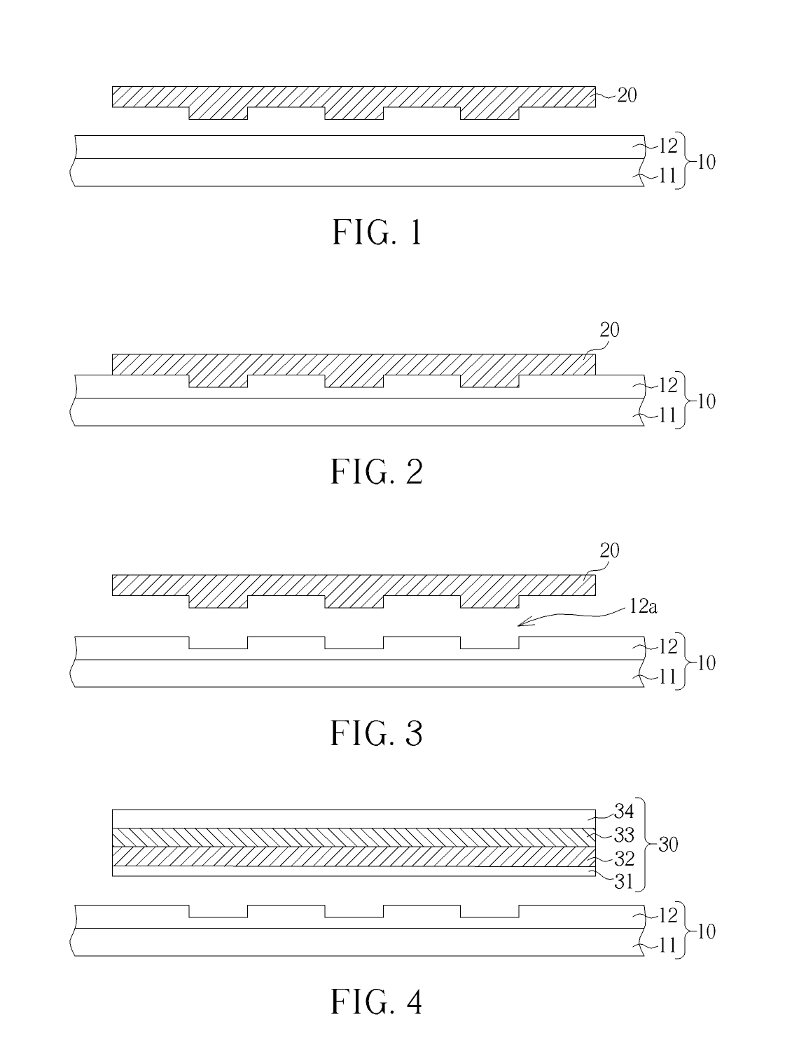

FIG. 1 to FIG. 5 are schematic, cross-sectional diagrams showing a method of fabricating an IMR film in accordance with one embodiment of the disclosure. As shown in FIG. 1 to FIG. 3, first, a carrier film 10 comprising a substrate 11 and a resin layer 12 bonding to a side of the substrate 11 is provided. According to the embodiment, the substrate 11 may comprise polyethylene terephthalate (PET) or polycarbonate (PC), but not limited thereto. According to the embodiment, the resin layer may comprise optical glue such as light curable materials that are completely cured under ultraviolet rays. Preferably, the resin layer 12 has a thickness of about 0.005˜0.3 mm. Subsequently, the carrier film 10 is pressed by a mold 20 carrying an embossed pattern under UV irradiation, to thereby transfer the embossed pattern 12a such as veined patterns or hair-like textures from the mold 20 to the resin layer 12. As shown in FIG. 2, the resin layer 12 is cured. As shown in FIG. 3, the mold 20 is removed or detached from the cured and embossed surface of the resin layer 12.

As shown in FIG. 4 and FIG. 5, a composite film 30 is pressed against embossed surface of the carrier film 10 to thereby transfer the embossed pattern 12 to the composite film 30. As shown in FIG. 5, a laminated IMR film 1 including the composite film 30 and the carrier film 10 is formed. According to the embodiment, the composite film 30 may comprise a UV-curable material layer 32, an ink layer 33, and an adhesive layer 34. The embossed pattern 12a is transferred to the UV-curable material layer 32. According to the embodiment, the UV-curable material layer 32 may include thermal-setting or semi-thermal setting coating. The composite film 30 may comprise a release film 31 between the UV-curable material layer 32 and the resin layer 12. According to the embodiment, the UV-curable material layer 32 may include thermal-setting or semi-thermal setting UV glue and has a thickness of about 0.05˜0.4 mm.

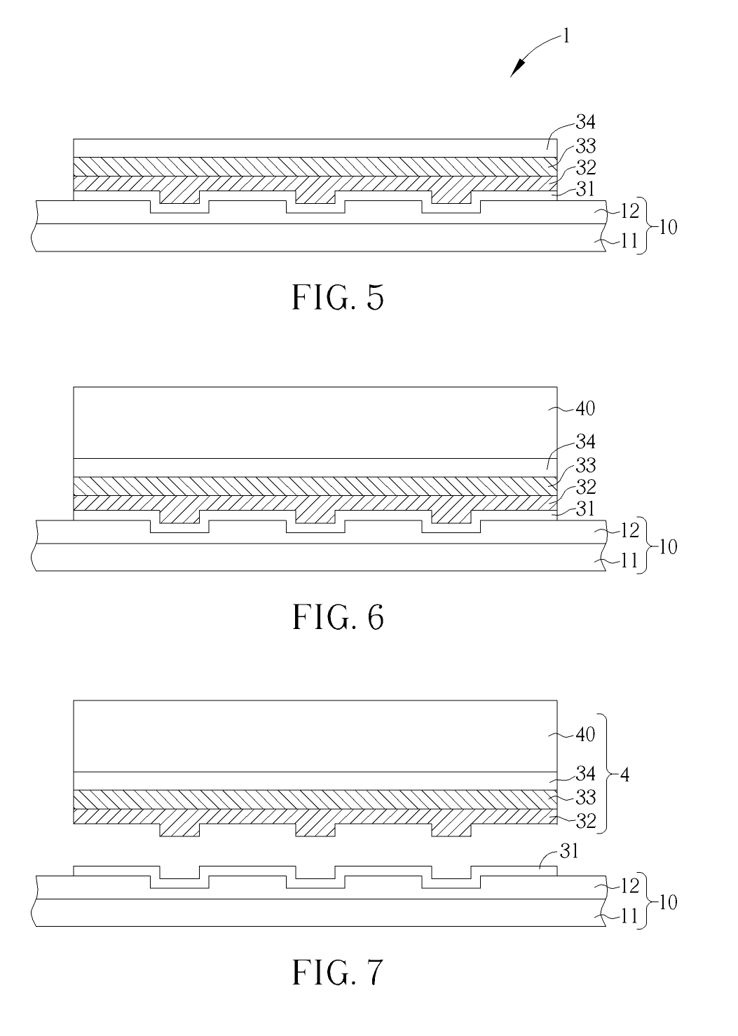

FIG. 6 and FIG. 7 illustrate an exemplary method of forming a plastic member or appearance object with texture of concave and convex veins or patterns by using the IMR film 1 in combination with the in-mold pattern transfer technique according to this disclosure. As shown in FIG. 6 and FIG. 7, by using an injection molding technique, a plastic layer 40 is molded on the adhesive layer 34 of the IMR film 1. According to the embodiment, the plastic layer 40 may be molded by using in-mold pattern transfer technology. For example, the IMR film 1 is first positioned in the mold cavity of a molding machine, a plastic body material is then injected into the mold cavity. After curing, the mold is detached and the UV-curable material layer 32 carrying the embossed pattern 12a that is bonding to the plastic layer 40 is separated from the release film 31 and the carrier film 10, thereby forming the plastic member or appearance object 4 with texture of concave and convex veins or patterns

Those skilled in the art will readily observe that numerous modifications and alterations of the device and method may be made while retaining the teachings of the disclosure. Accordingly, the above disclosure should be construed as limited only by the metes and bounds of the appended claims.

1. A method of fabricating an in mold release film object with embossed pattern, comprising:
preparing an in-mold release film by using the following stem
(a) providing a carrier film comprising a substrate and a resin layer having thereon the embossed pattern on a side of the substrate;
(b) laminating and pressing a composite film on the carrier film to thereby transferring the embossed pattern to the composite film; and
injection molding a material layer on the in-mold release film.

2. The method of fabricating an object with embossed pattern according to claim 1 wherein the composite film comprises a UV-curable material layer, an ink layer, and an adhesive layer.

3. The method of fabricating an object with embossed pattern according to claim 2 wherein the embossed pattern is transferred to the UV-curable material layer.

4. The method of fabricating an object with embossed pattern according to claim 2 further comprising a release film between the UV-curable material layer and the resin layer.

5. The method of fabricating an object with embossed pattern according to claim 2 wherein the UV-curable material layer comprises thermal-setting or semi-thermal setting UV glue.

6. The method of fabricating an object with embossed pattern according to claim 2 wherein the UV-curable material layer has a thickness of about 0.05˜0.4 mm.

7. The method of fabricating an object with embossed pattern according to claim 1 wherein the substrate comprises polyethylene terephthalate.

8. The method of fabricating an object with embossed pattern according to claim 1 wherein the in-mold release film comprises an adhesive layer.

9. The method of fabricating an object with embossed pattern according to claim 1 wherein the embossed pattern is formed by pressing the adhesive layer with a mold under UV irradiation.

10. The method of fabricating an object with embossed pattern according to claim 1 wherein the material layer comprises plastic.

11. The method of fabricating an object with embossed pattern according to claim 8 wherein the material layer is injection molded directly on the adhesive layer.
